(19) United States
(12) Patent Application Publication
(10) Pub. No.: US 2007/0105451 A1
(43) Pub. Date: May 10, 2007

(54) Home theatre connection system

(76) Inventor: Shan Hua, Allawah (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/591,172

(22) Filed: Oct. 31, 2006

(30) Foreign Application Priority Data
Oct. 31, 2005 (AU) 2005906011

(51) Int. Cl. H01R 24/00

(52) U.S. Cl. 439/676

(57) ABSTRACT

A panel (190, 1100) for connecting audio/visual equipment (120) comprises a front face (210) provided with a front port (220), a conductor (430) provided behind the front face and defining a bore (480) therethrough, and a housing (440) enclosing the conductor (430). A front end of the conductor (430) is accessible from the front port (220), and the housing (440) is provided with a rear port (450) providing access to a rear end of the conductor (430). The conductor (430) facilitates electrical communication between the front port (220) and the rear port (450). The front port (220) is configured to receive a plug connector (420), and the rear port (450) is configured to receive at least one of a further plug connector (500) and a bare wire conductor (490).

### FIELD OF THE INVENTION

The present invention relates generally to a connection system for audio/visual equipment.

### BACKGROUND

Home theatre equipment such as DVD players, high resolution display devices, surround sound systems, amplifiers, and the like have been readily accessible to the general public for quite some time. Indeed, equipment such as DVD players, plasma and LCD televisions, and high quality speakers have separately found their way into many homes within the last decade. Despite the relative ease of obtaining such equipment, however, setups involving a combination of the above working in concert to create a home theatre have been comparatively few.

It is suggested that obstacles to the wide spread pervasion of home theatre stem at least in part from the relative complexity of the wiring connections involved, the difficulties involved in physically connecting the relevant equipment, and the lack of architectural pre-planning of living areas to facilitate easy and aesthetically pleasing wire connections. Further, accessories to facilitate installation are not readily available. These problems particularly apply to wiring for the various active and passive loudspeakers such systems typically utilize.

Modern home theatre systems can comprise of 5.1, 6.1, or 7.1 channels, or more. The number of wire connections in such systems can be quite significant, and if not neatly installed behind walls, or under floors, for example, can result in making the living area in which the home theatre is installed untidy and also unsafe. Further, the sheer number of wires and sockets involved often create confusion as to which sockets belongs to which wires, and to which devices they should be connected to. Such problems are compounded by the tendency for equipment such as speakers, amplifiers, television, and the like to be positioned in tight spaces of a living area, such as in comers, on overhead shelfs or mantles, and so forth.

Further, as home entertainment systems usually involve a number of expensive components, home users are less inclined to perform the installation thereof by themselves out of concern of damaging one or more components due to incorrect wire connections, accidental short circuits, and the like. This further increases the costs, both financially and in terms of convenience, of home entertainment systems, resulting in the intended operational configuration of home theatre systems being implemented predominantly by enthusiasts and those of substantial wealth.

FIG. 10 illustrates an example of a known connection panel 1000 used in audio-visual systems. Such panel 1000 includes a number of “binding post” terminals 1002. Each binding post 1002 includes a threaded metal shaft 1004 typically including a transverse hole into which or about which a bare conductor wire (for a loudspeaker) may be secured. An insulated clamp 1006 may then be screwed onto the shaft 1004 to secure the wire. The clamp 1006 typically includes a central hole 1008 by which a “banana” plug (not illustrated) terminating the wire conductor may be plugged into the binding post 1002 as an alternate form of connection. A problem associated with the connection panel 1000 is in the ease at which accidental short circuiting may occur. The exposed threaded terminals allow for accidental short circuiting to occur from wires or objects crossed between two or more terminals, or by way of contact of a user's hand/finger. Further, the unmarked terminals make it difficult to ascertain to which terminal a wire should be connected. This further increases the chances of damaging expensive audio-visual equipment due to incorrect connection of, for example, an amplifier output to a microphone, or the like.

Moreover, the direct connection of speaker wires to the binding post 1002 requires some degree of skill and care, which if not exercised, can result in a wire not being fully in contact with the binding post 1002, or short circuiting between two or more binding post 1002. Plugs inserted into central hole 1008 increase the profile of an already high profile binding post 1002, making the installation unsightly and an obstruction to the positioning of furniture and the like in the vicinity of the connection panel 1000. Home theatre systems could be made more prevalent if wire connections could be realized more neatly and simply, and intuitively.

### SUMMARY

According to an aspect of the invention, a panel for connecting audio/visual equipment comprises a front face provided with at least one front port, a conductor provided behind the front face and defining at least one bore, a front end of the conductor being accessible from the front port, and a housing enclosing the conductor, the housing having a rear port providing rear access to the at least one bore of the conductor. The conductor facilitates electrical communication between the front port and the rear port, the front port being configured to receive a first plug connector and the rear port being configured to receive at least one of a further plug connector and a bare wire conductor to provide electrical connection with the first plug connector.

According to another aspect of the invention, a single conductor plug for connecting audio/visual equipment via a single conductor socket comprises a plug housing, and a plurality of tactile indicators provided on the plug housing. A spatial arrangement of the plurality of tactile indicators indicates a wire connection corresponding to the plug.

According to another aspect of the invention, a system for connecting audio/visual equipment comprises a connection panel having at least one front port and one rear port adapted to effect electrical communication therebetween, the rear port adapted to further effect electrical communication with a rear port of another connection panel. The system further comprises a connection wire operable to connect an input/output of an audio/visual device to the at least one front port, at least one sound field mark attached to the connectional panel to indicate a connection of the at least one front port, and at least one plug terminating the connection wire. A housing of the at least one plug is provided with a plurality of tactile indicators indicative of a wire connection corresponding to the plug.

### BRIEF DESCRIPTIONS OF THE DRAWINGS

Some aspects of the prior art and one or more embodiments of the present invention will now be described with reference to the drawings, in which:

FIG. 1 schematically illustrates a home theatre configuration in which the described arrangements may be used;

FIG. 2 illustrates a front view of a panel according to a preferred embodiment;

FIGS. 3A-3E illustrate exemplary configurations of the panel;

FIGS. 4A and 4B are cross sectional views of a panel according to a preferred embodiment;

FIGS. 5A-5C illustrate sound field marks according to a preferred embodiment;

FIGS. 6A and 6B illustrate exemplary sound field marks in greater detail;

FIG. 7 illustrates exemplary mappings of the sound field marks to corresponding wire connections;

FIG. 8 illustrates plug arrangements according to a preferred embodiment;

FIG. 9 illustrates exemplary mappings of tactile indicators to wire connections; and

FIG. 10 depicts a known panel for providing wire connections.

### DETAILED DESCRIPTION

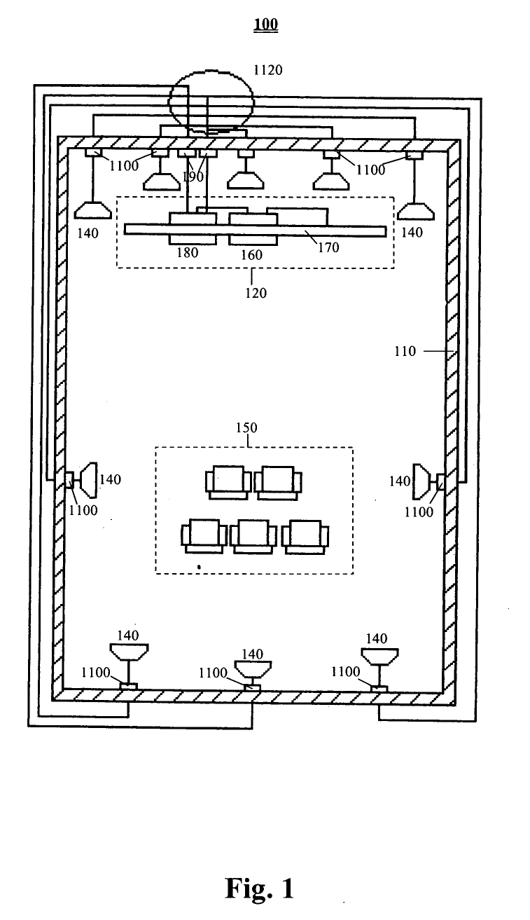

FIG. 1 depicts in top plan view a living area 100 to which aspects of the present invention are exemplarily applied. The living area 100 is enclosed by walls or partitions 110. Included within the living area 100 are an entertainment system 120, speakers 140, and a sitting area 150. The entertainment system 120 may for example include a DVD player 160, a television 170, and an audio-visual receiver (AVR) 180. The AVR 180 receives inputs from the DVD player 160 and the television 170, and provides outputs to the speakers 140.

Connection panels 190 and 1100 are provided in the wall 110. The connection panels 190 serve as input panels for receiving, for example, speaker outputs from the AVR 180. The connection panels 1100 serve as output panel for outputting signals to, for example, the speakers 140. The connection panels 190 and 1100, whilst depicted as separate physical panels in FIG. 1, may be integrated as a single connection panel. The connection panels 190 and 1100 are provided with a front face accessible from within the living area 100. The connection panels 190 are electrically connected to the connection panels 1100 by one or more wires 1120. The wires 1120 are connected to respective rear sides of the connection panels 190 and 1100 and may be run through the wall cavity, under the floor, in the ceiling, or by a combination of these.

The above arrangement allows the living area 100 to be free of running wires connecting the speakers 140 to the entertainment system 120.

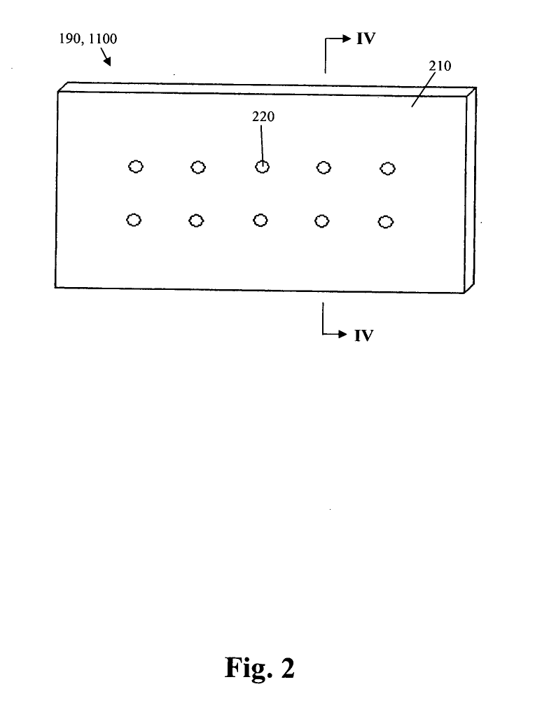

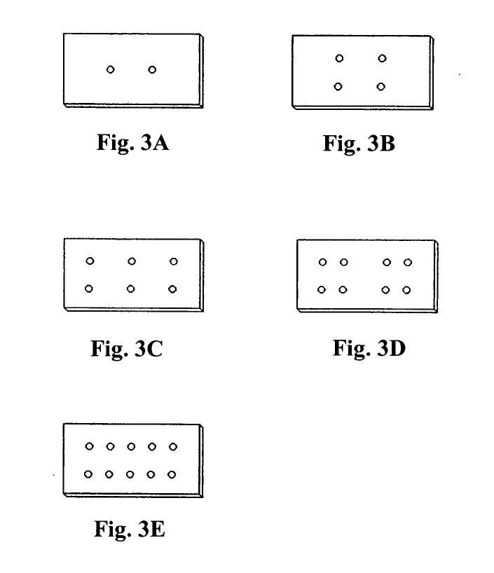

FIG. 2 illustrates the connection panel 190, 1100 in greater detail. The connection panel 190, 1100 has a front face 210 made of, for example, plastic. Input/output front ports 220 are provided in the front face 210. The connection panel 190, 1100 shown in FIG. 2 is provided with 10 input/output front ports, however, it should be understood that the number of front ports provided to a connection panel is not limited. It should further be understood that each front port 220 can serve as either an input or output port, and can be bi-directional if so required. FIGS. 3A to 3E illustrate other exemplary arrangements of input/output front ports for the connection panels 190, 1100. The connection panel of FIG. 3A would for example be more suitable for a single speaker output having two conductor connections, whereas the connection panel of FIG. 3E would for example be more suitable as the main input connection panel to which the AVR 180 is connected, offering 5 pairs of connections. It should be understood that any spatial arrangement, and number, of front ports may be provided on a connection panel.

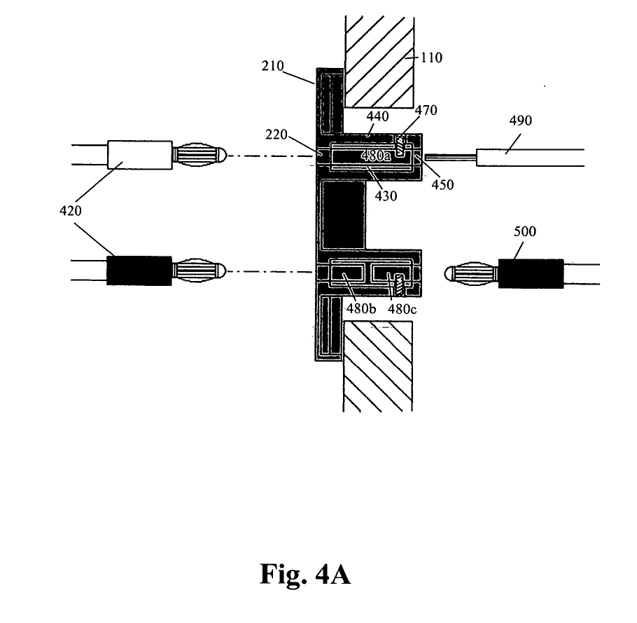

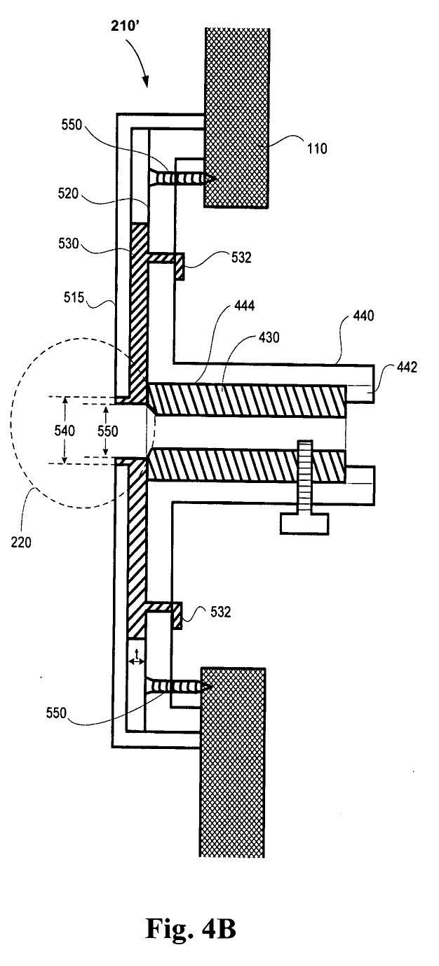

FIG. 4A depicts the connection panel of FIG. 2 in cross section along line IV-IV. A rear surface of the front face 210 of the connection panel is adapted to fit flush against the wall 110 when installed, and facilitate easy insertion of “banana”-style plugs 420 into the front ports 220. The front ports 220 provide access to a conductor 430. The conductor 430 is made of copper, gold, platinum, steel, or other material as known to, or may be later found by, those skilled in the art as being suitable, or preferable, for use as a conductor. The conductor 430 defines a bore 480a passing therethrough. Alternatively, the conductor 430 may define blind bores 480b, 480c therewithin. The arrangement employing the blind bores 480b, 480c prevents plugs and/or bare wires from being inserted too far from one end, such that a plug/bare wire inserted from the other end cannot be fully inserted. The conductor 430, and the bores 480a, 480b, 480c defined within the conductor 430, are preferably tubular. The bores 480a, 480b, 480c are hereinafter commonly referred to with reference numeral 480 when distinction therebetween is not necessary.

The front port 220 is sized such that accidental contact with the conductor 430 through the front port 220 is prevented. In particularly, a diameter and a depth of the front port 220 is preferably such that insertion of unintended objects, such as for example, an child/infant's finger, a pen, a stray plug/bare wire, and the like, to contact with the conductor 430 is prevented, or at least made to require substantial purposeful effort. Similarly, contact between conductors 430 is prevented, or made to require substantial purposeful effort. Additionally, a diameter of the bore 480 is sized so as to be moderately smaller than, or preferably equal to, that of the front port, to further render accidental contact with the conductor 430 less likely.

A conductor housing 440 of a non-conductive electrically insulating material is provided to substantially enclose each conductor 430 except for that exposed by the front port 220 and a rear port 450 providing access to a rear end of the bore 480. The conductor housing 440 may be integrally formed with the front face 220, or detachably provided. The conductor housing 440 is preferably moulded to fit the conductor 430 and the front face 220.

The rear port 450 is sized to prevent accidental contact with the conductor 430 through the rear port. Since, however, the connection panel 190, 1100 is generally installed in walls such that the rear port 450 is generally accessible only when the connection panel 190, 1100 is detached from the wall and then only by those looking to install or modify the connections of the rear port 450, the sizing of the rear port 450 need not necessarily be as specific as that of the front port 220. For example, a diameter and depth of the rear port 450 may be compromised to facilitate easier connection/installation. However, if the connection panel 190, 1100 is to be instead installed in, for example, a video cabinet, the sizing considerations of the rear port 450 should be similar to that of the front port 220.

The bore 480 and the front and rear ports 220, 450 are preferably axially aligned along a longitudinal axis perpendicular to the front face 210, unless otherwise dictated by the type of plug/termination being used. An arrangement in which the bore 480 and the front and rear ports 220, 450 are axially aligned along a longitudinal axis further assists in preventing accidental contact with the conductor 430.

Screw holes may be provided in the conductor housing 430 to allow for the provision of an engagement screw 470. The engagement screws 470 can be used to secure the ends of the wires 1120 in the form of bare wire conductors 490 within the conductor 430 inserted through the rear port 450. The engagement screws 470 are provided through the conductor housing into the bore 480 in a transverse direction to the longitudinal axis of the conductor 430. Alternatively, the ends of the wires 1120 can be provided with plugs 500 to facilitate connection of the wires 1120 with the connection panels 190, 1100 via the rear port 450.

The conductor housing 440, in substantially enclosing the conductor 430 and having a rear port 450 as hereinbefore described, prevents the conductor 430, from being externally exposed. This arrangement assists in preventing accidental short-circuiting between conductors, and between each conductor and other electrical components such as wires and the like. Further, safety is enhanced by preventing accidental contact between a conductor and a user/installer. Thus, in view of the low voltages usually experienced with such equipment, installation may be safely effected by unlicensed/unskilled persons. The conductor housing 440 and the front face 210 further have the effect of retarding the onset of corrosion on the conductor 430.

FIG. 4B is a cross section of a specific implementation 210′ of a panel 210 of FIG. 2, illustrating a preferred construction of the connection panel 190, 1100 in detail. The connection panel 190, 1100 of FIG. 4B is provided with a front cover 515, detachable to expose a backing face 520 and the front of the conductor 430. A non-conductive plate 530 is detachably attached to the backing face 520, between the front cover 515 and the backing face 520. The front cover 515 and the non-conductive plate 530 are provided with apertures 540, 550 to form the front port 220. Preferably, a diameter of the aperture 550 of the non-conductive plate 530 is equal to that of the bore 480, or between that of the bore 480 and the front cover 515.

The non-conductive plate 530 can be sized to further assist in preventing accidental contact with the conductor 430 through the front port 220. Specifically, the non-conductive plate 530 may be provided with a thickness t to increase the effective insertion depth required to effect contact with the conductor 430 via the front port 220. Further, as the diameter of the aperture 550 is preferably equal to or between that of the aperture 540 and the bore 480, a portion of the non-conductive plate 530 is at least partially visible through the front port 220. The non-conductive plate 530 can hence be coloured (e.g. red or black) to provide an indication of a connection type of the front port 220, and to suitably contrast a colour (e.g. white) of the front cover 515.

As seen in FIG. 4B, the conductor housing 440 is integrally formed, by moulding for example, with the backing face 520, to form a channel 444 into which the conductor 430 is insertable. The housing 440 has an annular end 442 which defines the rear port 450 and provides access to wires 490 and plugs 500 within the wall cavity. The channel 444 has an open front end permitting insertion of the conductor 430, which is held in position within the channel 444 by the non-conductive plate 530. The plate 530 is coupled to the backing face using tabs 532 which slidably engage in slots (not illustrated) in the back face 520. The cover 515 fits over the plate 530 and onto the backing face 520 in a neat interference fit. Screws 550 may be used to secure the backing face 520 to the wall 110.

Connection panels 190, 1100 are installed into walls (or partitions, etc) at positions best suited to a user's home theatre system set up. The panels 190, 1100 may be pre-installed by a builder, as would be preferable in the case of a new building, or may be later installed in an existing building by a user or a tradesperson. In the example of FIG. 1, the home theatre system includes front speakers, rear speakers, and centre speakers. Accordingly, connection panels 1100 are provided at an end of the living area 100 in front of the sitting area 150, an end of the living area behind the sitting area 150, and at the sides of the living area in line with the sitting area 150. Wires from the AVR 180 are connected to the connection panel 190. Preferably, the wires from the AVR 180 each terminate in a plug 420, such as a banana plug. Each plug 420 is configured to be a conductor of a single signal, and the wires may be formed of a solid conductor, or a multi-strand conductor. A typical loudspeaker connection has a (+) conductor and a (−) conductor each with a corresponding plugs 420.

One plug 420 is inserted through the front port 220 of the front face 210 of the connection panel 190 into the bore 480a, 480b.

Wires connecting the connection panel 190 to another connection panel 1100 are inserted into the rear of the connection panel 190 and the connection panel 1100. Preferably, the connection panel 190, 1100 is installed into the wall 110 in a manner that facilitates easy detachment of the connection panel 190, 1100 from the wall so that the rear of the connection panel 190, 1100 may be accessed. Bare wire conductors 490 are inserted into the rear of the connection panels 190, 1100 and each secured in a corresponding bore 480 by the corresponding engagement screw 470. Alternatively, the wire conductor may terminate in a plug 500 each adapted to mate with the conductor 430. The conductor 430 may be adapted to mate with different terminations for the front and rear ends. In such a case, the front port 220 and the rear port 450 are accordingly adapted to accept the respective terminations.

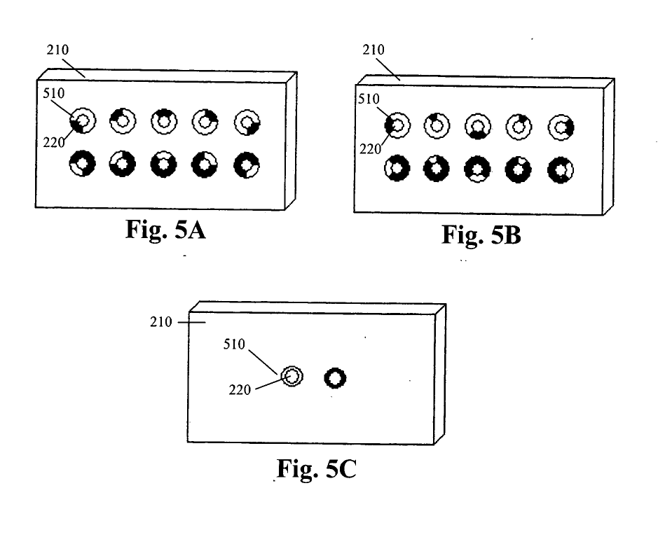

In specific implementations, as seen in FIGS. 5A-5C, the front face 210 of the connection panel 190, 1100 is provided with one or more sound field marks 510, each corresponding to one of the ports 220. The sound field marks 510 are preferably provided around a portion of the perimeter of the port 220, to indicate a connection used for the corresponding port. The sound field marks 510 are preferably formed with a varying tactile feel around a perimeter thereof, but may also be a visual-only indicator, for example printed or adhered to the front face 210.

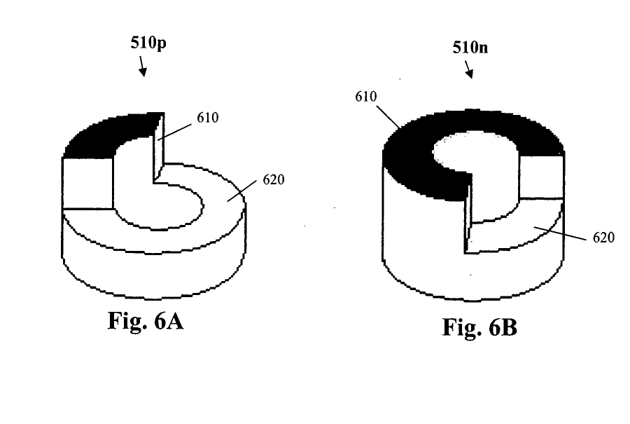

FIGS. 6A and 6B illustrate two exemplary tactile sound field marks 510p, 510n. The sound field marks 510p, 510n are each provided with an annular base 620, and a segmented annular raised portion 610 provided at an elevated level with respect to the annular base 620 The raised portions 610 provide a tactile indication of the connections of the corresponding ports to which the tactile sound field marks 510p, 510n are attached. Specifically, the position of the raised portions 610 around the annular base 620 can be mapped to the position of the device within the home theatre system that the port 220 having the sound field mark 510p, 510n corresponds.

Further, the area of the annular base 620 taken up by the raised portions 610 can be mapped to a connection type (i.e. positive, negative, high voltage, low, voltage, etc). For example, the sound field mark 510p having a raised portion 610 taking up a minority area of the annular base 620 can be mapped to indicate a positive connections. Similarly, the sound field mark 510n having a raised portion 610 taking up a majority area of the annular base 620 can be mapped to indicate a negative connection.

The position of the raised portion 610, together with the area it takes up, indicate the connection of the port 220 (front, left, right, rear, etc.) and the connection type of the port 220 (positive, negative, high voltage, low voltage, etc.). For example, the sound field mark 510p of FIG. 6A indicates a positive connection to a front-left speaker/device. Similarly, the sound field mark 510n indicates a negative connection to a rear right speaker/device.

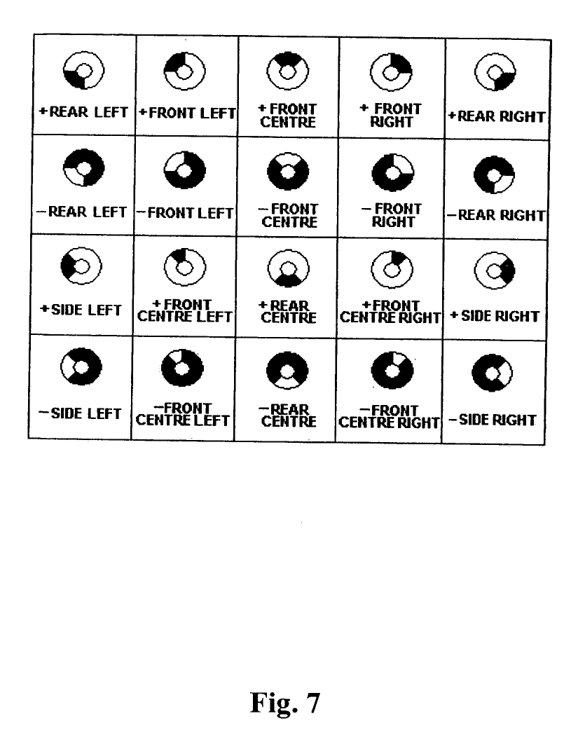

The tactile sound field marks 510p, 510n are preferably provided as complementary pairs, with a first mark of a pair having a segmented raised portion taking up a minority area of the annular base 620, and the second mark of the pair having a segmented raised portion taking up a majority area. The segmented raised portion of the second mark is complementarily positioned around the annular base 620 with respect to the first mark. 30 That is, the second mark of the pair appears as an inverse or relief of the first mark. The first and second sound field marks can therefore be used to indicate ports corresponding to the same device (e.g. front-left speaker), but differentiating between connection types for the device (e.g. positive/negative wires). FIG. 7 provides an exemplary correspondence of various sound field marks to connections.

The sound field marks 510 may be integrally formed with the connection panels 190, 1100, or preferably, detachably provided. The tactile variation of the sound field marks 510p, 510n can be provided by means other than by raised portion 610. For example, the tactile sound field marks 510p, 510n may be formed with varying smoothness, protrusions, depressions, materials, and the like. The tactile sound field marks 510p, 510n allow the connection of a port to be ascertained without requiring a visual on the connection panels 190, 1100. Such an arrangement is particularly advantageous in situations where space around the connection panels 190, 1100 is limited, or awkward to access.

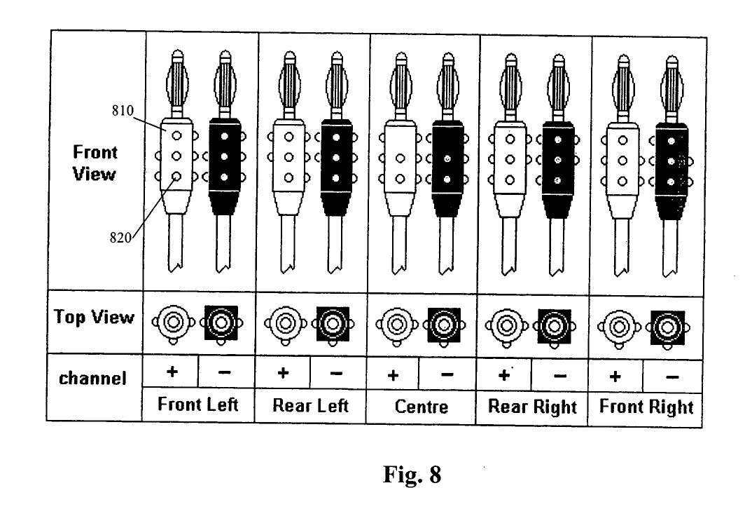

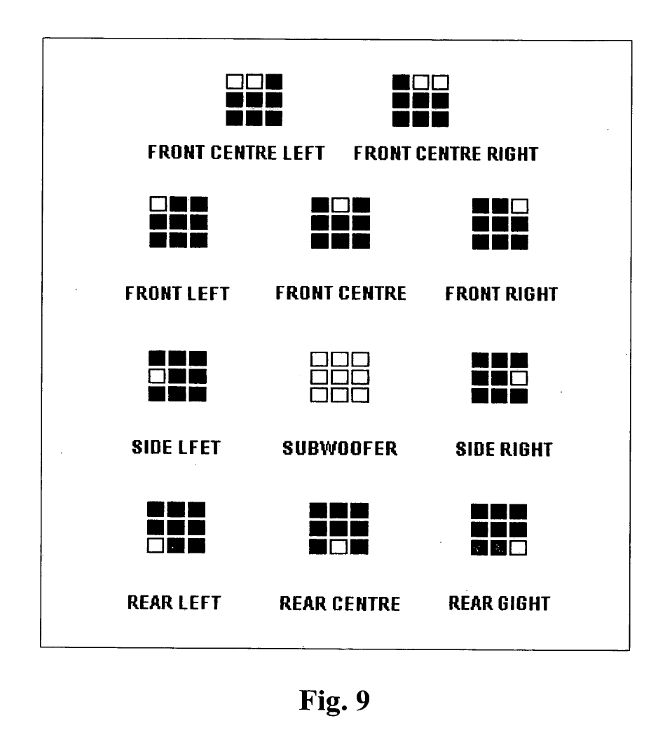

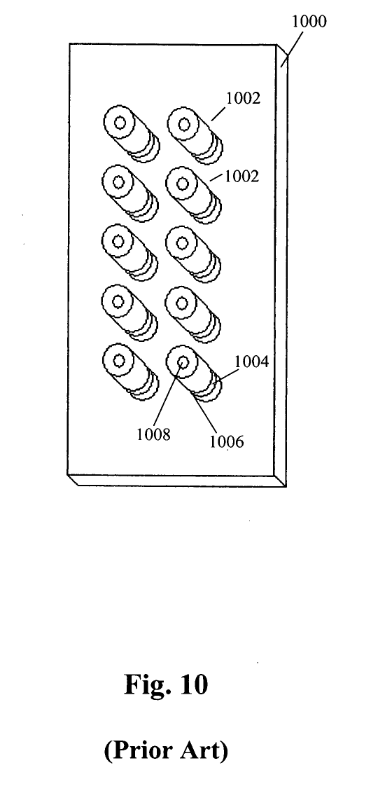

As seen in FIG. 8, plugs 810 are provided with tactile indicators 820. The tactile indicators 820 of each plug 810 are eight, or less, of a set of nine indicators, where the location of the missing indicators provides an indication of the wire connection of the plug 810. It should be understood that the number of tactile indicators 820 is not limited to nine, and that the tactile indicators need not necessarily be protrusions as shown in FIG. 6. The tactile indicators 820 may for example be depressions in the plugs, or may also be similar in design to the sound field marks 510p, 510n previously described. FIG. 9 shows exemplary mappings of arrangements of tactile indicators to wire connections.

The tactile indicators 820 allow a user/installer to determine the wire connection corresponding to a plug 810 without a direct visual on the plug 810 and without needing to trace the plug back along the wire to its origin/destination. This is particularly advantageous in situations where space around a connection panel, or port, to which the plug 810 is inserted is limited or awkward to access.

The foregoing describes only some embodiments of the present invention, and modifications and/or changes can be made thereto without departing from the scope and spirit of the invention, the embodiments being illustrative and not restrictive.

The claims defining the invention are as follows:

1. A panel for connecting audio/visual equipment, the panel comprising:
a front face provided with at least one front port;
a conductor provided behind the front face and defining at least one bore, a front end of the conductor being accessible from the front port; and
a housing enclosing the conductor, the housing having a rear port providing rear access to the at least one bore of the conductor, wherein
the conductor facilitates electrical communication between the front port and the rear port, the front port being configured to receive a first plug connector and the rear port being configured to receive at least one of a further plug connector and a bare wire conductor to provide electrical connection with the first plug connector.

2. The panel as set forth in claim 1, wherein the front face comprises:
a backing face;
a front cover detachably attached to the backing face; and
a non-conductive plate provided between the front cover and the backing face, wherein
the front cover and the non-conductive plate are provided with apertures at positions corresponding to the front port.

3. The panel as set forth in claim 2, wherein a diameter of the apertures of the non-conductive plate is equal to or between a diameter of the aperture of the front cover and a diameter of the at least one bore.

4. The panel as set forth in claim 1, wherein the conductor is a tubular conductor having a bore therethrough.

5. The panel as set forth in claim 1, wherein at least one of the front port and the rear port is axially aligned with the at least one bore along a common longitudinal axis perpendicular to the front face.

6. The panel as set forth in claim 1, wherein the conductor is a tubular conductor defining a first bore extending from the front port and a second bore extending from the rear port.

7. The panel as set forth in claim 6, wherein the first bore and the front port are axially aligned along a common longitudinal axis perpendicular to the front face.

8. The panel as set forth in claim 6, wherein the second bore and the rear port are axially aligned along a common longitudinal axis perpendicular to the front face.

9. The panel as set forth in claim 1, wherein a size of the front port is such as to prevent accidental contact with the conductor through the front port.

10. The panel as set forth in claim 1, wherein a size of the rear port is such as to prevent accidental contact with the conductor through the rear port.

11. The panel as set forth in claim 1, wherein the front port and the front end of the conductor are adapted to received a banana plug.

12. The panel as set forth in claim 1, wherein the rear port and the rear end of the conductor are adapted to received a banana plug.

13. The panel as set forth in claim 1, further comprising a securing means provided in the vicinity of the rear end of the conductor, the securing means being adapted to secure the bare wire conductor within the bore.

14. The panel as set forth in claim 13 when dependent on any one of claims 6 to 8, further comprising a securing means provided in the second bore, the securing means being adapted to secure the bare wire conductor within the second bore.

15. The panel as set forth in claim 13, wherein the securing means is a screw provided at least partially through the housing and the conductor.

16. The panel as set forth in claim 1, further comprising a sound field marker provided on the front face, the sound field marker being indicative of a connection corresponding to a front port.

17. The panel as set forth in claim 16, wherein the sound field marker is tactilely identifiable.

18. The panel as set forth in claim 16, wherein the sound field marker comprises a raised portion, and a position of the raised portion around the perimeter of the front port indicates the connection corresponding to the front port.

19. The panel as set forth in claim 16, wherein the sound field marker comprises a raised portion, and an area taken up by the raised portion around the perimeter of the front port indicates the connection type corresponding to the front port.

20. The panel as set forth in claim 16, wherein the sound field marker is detachably attached to the front panel.

21. The panel as set forth in claim 2, wherein the non-conductive plate is coloured to indicate a connection of the front port.

22. A single conductor plug for connecting audio/visual equipment via a single conductor socket, said plug comprising:
a plug housing; and
a plurality of tactile indicators provided on the plug housing, wherein
a spatial arrangement of the plurality of tactile indicators indicates a wire connection corresponding to the plug.

23. The plug as set forth in claim 22, wherein the tactile indicators are provided as protrusions on the plug housing.

24. A system for connecting audio/visual equipment, comprising:
a connection panel having at least one front port and one rear port adapted to effect electrical communication therebetween, the rear port adapted to further effect electrical communication with a rear port of another connection panel;
a connection wire operable to connect an input/output of an audio/visual device to the at least one front port;
at least one sound field mark attached to the connectional panel to indicate a connection of the at least one front port; and
at least one plug terminating the connection wire, a housing of the at least one plug being provided with a plurality of tactile indicators indicative of a wire connection corresponding to the plug.
